(19) United States
(12) Patent Application Publication
(10) Pub. No.: US 2024/0227674 A9
(43) Pub. Date: Jul. 11, 2024

(54) REAR VIEW MIRROR STEERING STRUCTURE

(71) Applicant: Sungin Technology Co., Ltd., Tainan City (TW)

(72) Inventor: Chung-Wei Liang, Tainan City (TW)

(21) Appl. No.: 18/464,728

(22) Filed: Sep. 11, 2023

(30) Foreign Application Priority Data
Oct. 21, 2022 (TW) 111211477

(51) Int. Cl. B60R 1/06

(52) U.S. Cl. CPC B60R 1/06

(57) ABSTRACT

The present invention is related to a rear view mirror steering structure. A lens is embedded on one side of the mirror shell of the rear view mirror, wherein the mirror shell is configured with a plurality of through holes and an arched recess on the outside thereof, a screw is used to go through the through hole to secure the mirror shell to the screw hole of a hollow fixing base, a wear-resistant gasket is accommodated inside the hollow fixing base, one end of a universal shaft rod is utilized to joint with the wear-resistant gasket and the hollow fixing base to be pivotally fixed with a frame, and the other end of the universal shaft rod has a ball head, wherein the top end of the ball head is tightly abutted upon the arch recessed slot of the mirror shell and the side end is attached to the inner ring wall of the wear-resistant gasket, and due to the mirror shell being secured on the hollow fixing base and the ball head of the universal shaft rod being attached to the wear-resistant gasket, the rear view mirror can be turned more smoothly and the abrasion of components can be reduced and moreover, the service life can be extended and the components can be replaced and repaired conveniently.

### BACKGROUND OF THE INVENTION

The present invention relates generally to a rear view mirror steering structure, and more particularly to an innovative structure that can reduce wearing of components, extend the product life cycle, and facilitate replacement or repair of components.

### DESCRIPTION OF THE RELATED ART

Accordingly, to have clear field of view on the back area, the common vehicles (such as a motorcycle) are frequently necessary to be turned the mirror shell to adjust the angle of the mirror surface. With reference to FIGS. 1, 2, the mirror shell 10 of a prior-art rear view mirror 1 is configured with a hollow through opening 11 at the central position thereof, a lens 12 is embedded on one side of the mirror shell 10 and jointed to the through opening 11 via one end of an universal shaft rod 13 and pivoted and fixed with a frame 14 on the outside of the mirror shell 10. When turning the rear view mirror 1, the frequent movement and friction between the universal shaft rod 13 and the mirror shell 10 will cause wearing and loss of the sealing effect. As a result, water will enter the components to cause rusting and corrosion, and consequently the rear view mirror 1 cannot be turned smoothly. In view of this, the inventor of the present invention carried out in-depth research to improve the prior art and has finally developed the present invention.

### SUMMARY OF THE INVENTION

It is a primary objective of the present invention to provide a rear view mirror steering structure that can be turned smoothly with less wearing of components and longer life cycle, and the components can be replaced or repaired easily

To achieve the above-mentioned objective, the present invention provides a rear view mirror embedded with a lens on one side of a mirror shell thereof, wherein the mirror shell is configured with a plurality of through holes and has an arch recessed slot on the outer side, a screw is used to go through the through hole to secure on screw hole of a hollow fixing base, thereby enabling the mirror shell to be combined with the hollow fixing base, and a wear-resistant gasket is accommodated inside the hollow fixing base and one end of a universal rod is used to joint with the wear-resistant gasket and the hollow fixing base to pivot and fix with a frame, and a ball head is configured on the other end of the universal shaft rod, the top end of the ball head is tightly abutted upon the arch recessed slot of the mirror shell and the side end is attached to the inner ring wall of the wear-resistant gasket.

According to the above-mentioned rear view mirror steering structure, the wear-resistant gasket can be made of nylon material.

Other features and advantages of the present invention will become apparent from the following description of the invention which refers to the accompanying embodiments and drawings.

### BRIEF DESCRIPTION OF THE DRAWINGS

FIG. 1 is an exploded perspective view of the prior art.

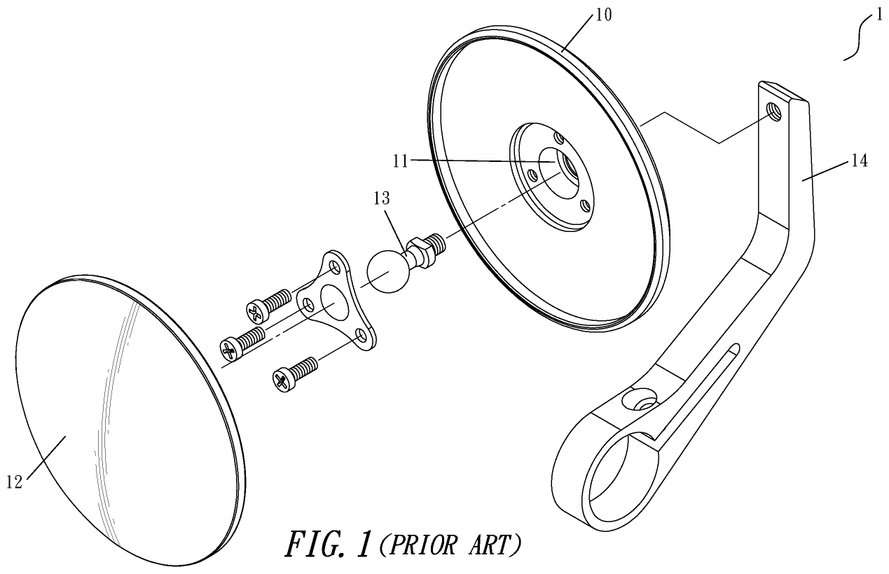

FIG. 2 is a combined sectional view of the prior art.

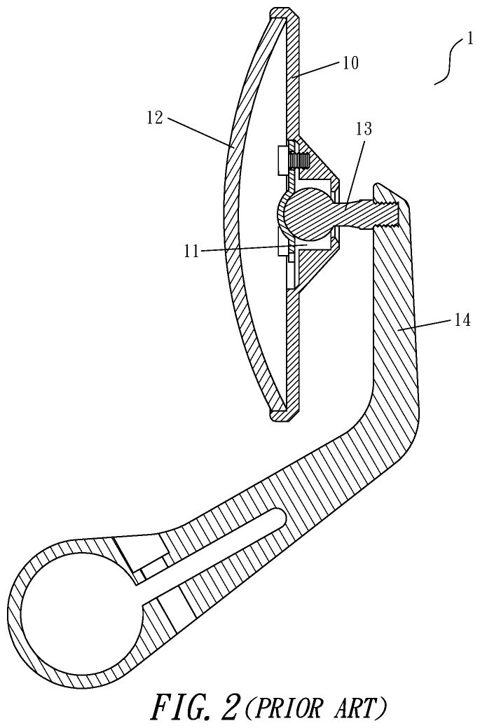

FIG. 3 is a perspective view of an embodiment of the invention.

FIG. 4 is an exploded perspective view of an embodiment of the invention.

FIG. 5 is a combined sectional view of an embodiment of the invention.

### DETAILED DESCRIPTION OF EMBODIMENTS OF THE INVENTION

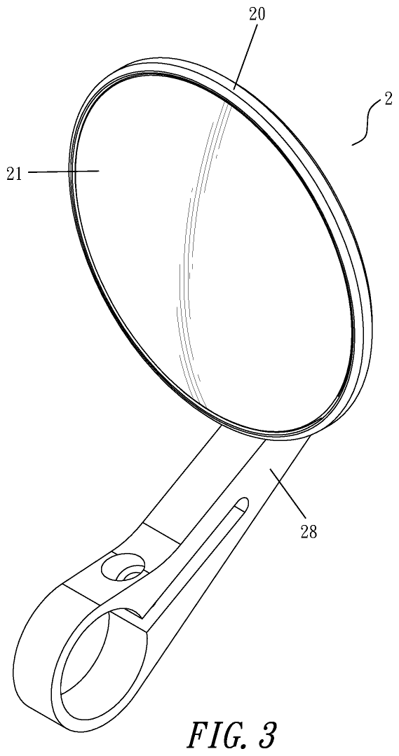

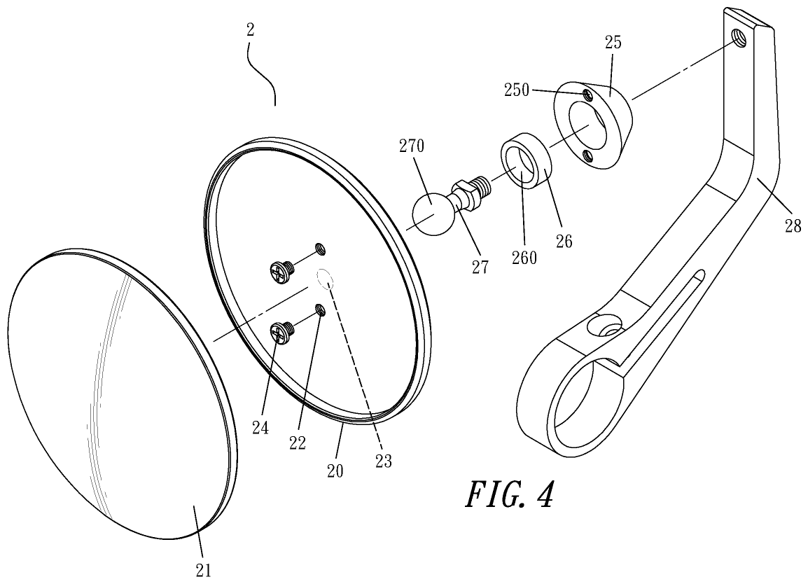

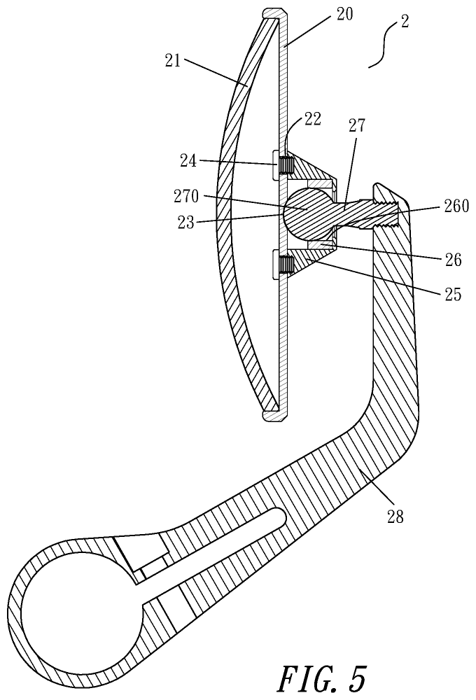

With reference to FIGS. 3-5, a lens 21 is embedded on one side of the mirror shell 20 of the rear view mirror 2, wherein the mirror shell 20 is configured with a plurality of through holes 22 and provided with an arch recessed slot 23 on the outside, and a screw 24 is used to joint through the through hole 22 to secure on a screw hole 250 of a hollow fixing based 25, thereby enabling the mirror shell 20 to be combined with the hollow fixing base 25. A wear-resistant gasket 26 is accommodated inside the hollow fixing base 25 and the wear-resistant gasket 26 is made of nylon material having the properties of good sealing, high wear resistance and corrosion resistance. One end of a universal shaft rod 27 is used to joint with the wear-resistant gasket 26 and the hollow fixing base 25 and pivotally fixed with a frame 28, and the other end of the universal shaft rod 27 is provided with a ball head 270, wherein the top end of the ball head 270 is tightly abutted upon the top of an arch recessed slot 23 of the mirror shell 20 and the side end is attached to an inner ring wall 260 of the wear-resistant gasket 26.

Thus, the mirror shell 20 is secured on the hollow fixing base 25, and when turning the rear view mirror, the top end of the ball head 270 of the universal rod 27 abutted upon the arch recessed slot 23 of the mirror shell 20 enables the rear view mirror 2 to be turned more smoothly, and due to the side end of the ball head 270 attached to the inner ring wall 260 of the wear-resistant gasket 26, only a wear-resistant gasket 26 is necessary to be replaced after a long-term use and friction, thereby achieving the effect of reducing the abrasion of the components, extending the service life, easy replacement and repair of the components.

Although the invention has been explained in relation to its preferred embodiment, it is to be understood that many other possible modifications and variations can be made without departing from the spirit and scope of the invention as hereinafter claimed.

What is claimed is:

1. A rear view mirror steering structure, wherein a lens is embedded on one side of a mirror shell of the rear view mirror, the mirror shell is configured with a plurality of through holes and an arch recessed slot is configured on the outside of the mirror shell, a screw is used to go through the through hole to secure the mirror shell on a screw hole of a hollow fixing base, a wear-resistant gasket is accommodated inside the hollow fixing base and one end of a universal shaft rod is used to joint with the wear-resistant gasket and the hollow fixing base to pivotally fix with a frame, the other end of the universal shaft rod is configured with a ball head, the top end of the ball head is tightly abutted upon the top of the arch recessed slot of the mirror shell and the side end is attached to an inner ring wall of the wear-resistant gasket.

2. The rear view mirror steering structure of claim 1, wherein the wear-resistant gasket is made of a nylon material.
